(19) United States
(12) Patent Application Publication
(10) Pub. No.: US 2015/0185323 A1
(43) Pub. Date: Jul. 2, 2015

(54) Projector

(71) Applicant: Funai Electric Co., Ltd., Osaka (JP)

(72) Inventor: Atsuhiko CHIKAOKA, Kyoto-shi (JP)

(21) Appl. No.: 14/580,385

(22) Filed: Dec. 23, 2014

(30) Foreign Application Priority Data
Dec. 26, 2013 (JP) 2013-269223

(51) Int. Cl. G01S 17/06; G01B 11/14

(52) U.S. Cl. CPC G01S 17/06; G01B 11/14

(57) ABSTRACT

A projector includes a projection portion, a display portion having a projection surface, movable in a pushed direction so that the projection surface is pushed, a push detection portion configured to detect movement of the display portion, a light detection portion detecting reflected light reflected by a detection object, and a control portion acquiring the position of the detection object on the projection surface on the basis of the detection result of the reflected light detected by the light detection portion when the push detection portion detects the push into the display portion.

### BACKGROUND OF THE INVENTION

1. Field of the Invention

The present invention relates to a projector, and more particularly, it relates to a projector including a projection portion projecting an image and a light detection portion detecting reflected light reflected by a detection object.

2. Description of the Background Art

A projector or the like including a projection portion projecting an image and a light detection portion detecting reflected light reflected by a detection object is known in general. Such a projector is disclosed in Japanese Patent Laying-Open No. 2005-242725.

Japanese Patent Laying-Open No. 2005-242725 discloses a portable telephone including an image projection portion configured to project an operation image on an external projection surface and a light emission/detection portion (light detection portion) emitting detection light for detecting a detection object and receiving reflected light reflected by the detection object, having a projector function. In this portable telephone, the operation image of a virtual keyboard, a menu screen, or the like is projected on the external projection surface.

In the portable telephone according to Japanese Patent Laying-Open No. 2005-242725, however, a user only touches a prescribed position of the operation image on the external projection surface when operating (touching) the operation image of the virtual keyboard, the menu screen, or the like projected on the external projection surface, and hence there is such a problem that a feel is slightly transmitted through the user's fingertip in operation and the user hardly obtains a sense of operation.

### SUMMARY OF THE INVENTION

The present invention has been proposed in order to solve the aforementioned problem, and an object of the present invention is to provide a projector in which a user can obtain a sense of operation when operating an image projected on a projection surface.

In order to attain the aforementioned object, a projector according to an aspect of the present invention includes a projection portion projecting an image, a display portion having a projection surface configured to display the image projected by the projection portion, movable in a pushed direction so that the projection surface is pushed, a push detection portion configured to detect movement of the display portion caused by push, a light detection portion detecting reflected light of projection light projected on the projection surface by the projection portion and reflected by a detection object, and a control portion acquiring the position of the detection object on the projection surface on the basis of the detection result of the reflected light detected by the light detection portion when the push detection portion detects the push into the display portion.

As hereinabove described, the projector according to the aspect of the present invention is provided with the display portion movable in the pushed direction so that the projection surface is pushed, whereby a user can push the display portion when operating an operation image projected on the projection surface, and hence the user can obtain a sense of operation (the feel of push) unlike the case where the user only touches the projection surface. Furthermore, the projector is provided with the control portion acquiring the position of the detection object on the projection surface on the basis of the detection result of the reflected light detected by the light detection portion when the push detection portion detects the push into the display portion. Thus, a processing operation for acquiring the position is performed only when the push into the display portion is detected, unlike the case where the control portion acquires the position constantly, and hence the position of the detection object on the projection surface can be grasped while the processing load on the control portion is reduced.

In the aforementioned projector according to the aspect, the control portion is preferably configured to control the projection portion to project a detection image on the projection surface on the basis of detection of the push into the display portion by the push detection portion and perform control of acquiring the position of the detection object on the projection surface on the basis of the detection result of the reflected light of the projection light forming the detection image, detected by the light detection portion. According to this structure, both the detection image and the operation image can be projected by the projection portion, and hence an increase in the number of components of the projection portion of the projector can be suppressed, unlike the case where a projection portion for the detection image is provided separately from a projection portion for the operation image. Furthermore, the projection light forming the detection image dedicated for detection is employed for detection, whereby the position of the detection object can be accurately detected, unlike the case where projection light for the operation image is employed for detection. In addition, unlike the case where the detection image (detection light) and the operation image are simultaneously projected on a constant basis, the position can be detected simply by projecting the detection image temporarily when the user operates the operation image projected on the projection surface, and hence superimpose display of the detection image and the operation image can be suppressed. Thus, difficulty in viewing the operation image can be suppressed.

In the aforementioned projector according to the aspect, the control portion is preferably configured to control the projection portion to project a detection image on the projection surface when the push detection portion detects the push into the display portion and control the projection portion to project an operation image different from the detection image on the projection surface when the projection portion completes projection of the detection image on the projection surface. According to this structure, the detection image can be properly projected on the projection surface when it is necessary to detect the position of the detection object, and the operation image can be promptly projected on the projection surface after the position of the detection object is detected.

In the aforementioned structure in which the projection portion projects the detection image on the projection surface, the control portion is preferably configured to control the projection portion to project the detection image and an operation image on the projection surface in a state where the detection image and the operation image different from the detection image are synthesized. According to this structure, both the detection image and the operation image are projected on the projection surface even during the projection of the detection image on the projection surface, and hence the position of the detection object can be acquired while the user is allowed to visually confirm the operation image.

In the aforementioned structure in which the projection portion projects the detection image on the projection surface, the control portion is preferably configured to control the projection portion to project the detection image on the projection surface during a period from when the push detection portion detects the push into the display portion until when the push into the display portion is released. According to this structure, the detection image can be projected during the push of the detection object into the projection surface (during contact of the detection object with the projection surface), and hence the light forming the detection image can be reliably reflected by the detection object. Consequently, the position of the detection object can be reliably acquired on the basis of the reflected light.

In the aforementioned structure in which the projection portion projects the detection image on the projection surface, the projection light forming the detection image is preferably formed by light of a single wavelength. According to this structure, the reflected light of the single wavelength reflected by the detection object can be easily detected by the light detection portion, unlike the case where the detection image is formed by light of various wavelengths.

In this case, the projection light forming the detection image is preferably formed by light of a red wavelength. A light receiving element such as a PD (photodiode) whose photosensitivity is generally high in a red wavelength region is employed as a light receiving element of the light detection portion. Therefore, according to the aforementioned structure, the light of the red wavelength which is a wavelength for which the photosensitivity of the light receiving element of the light detection portion is high is employed, and hence the reflected light reflected by the detection object can be more easily detected by the light detection portion.

In the aforementioned structure in which the projection portion projects the detection image on the projection surface, the detection image is preferably an animation image formed by sequentially projecting a plurality of detection images. According to this structure, the detection image can be displayed as a moving image (input effect) for notification of a push operation. Consequently, the detection image for position detection can be projected while the user is inhibited from feeling unnatural.

In this case, the plurality of detection images are preferably the animation image sequentially changing by gradually enlarging or reducing a first detection image of the plurality of detection images. According to this structure, the user can be further inhibited from feeling unnatural by the detection images for position detection.

In the aforementioned structure in which the detection image is the animation image, the control portion is preferably configured to perform control of acquiring the position of the detection object on the projection surface on the basis of the detection result of the reflected light of the projection light forming a last detection image of the plurality of detection images constituting the animation image, detected by the light detection portion. According to this structure, the detection result of the reflected light of the projection light forming the detection image projected last can be employed, and hence the position of the detection object on the projection surface can be acquired in a state where the position of the detection object on the projection surface is fixed. Consequently, the position of the detection object on the projection surface can be accurately acquired.

In this case, the last detection image is preferably an image projected on a substantially entire region of the projection surface, and the control portion is preferably configured to perform control of acquiring the position of the detection object on the projection surface on the basis of the detection result of the reflected light of the projection light forming the last detection image detected by the light detection portion. According to this structure, the projection light forming the last detection image can be reliably reflected by the detection object, unlike the case where the last detection image is projected only on a partial region of the projection surface. Consequently, the position of the detection object on the projection surface can be reliably and accurately acquired regardless of the position of the detection object.

In the aforementioned structure in which the detection image is the animation image, the control portion is preferably configured to perform control of acquiring the position of the detection object on the projection surface on the basis of the detection result of the reflected light of the projection light forming at least one of the plurality of detection images constituting the animation image, detected by the light detection portion. According to this structure, the position of the detection object on the projection surface can be reliably acquired even in the case where the detection images are the animation image.

In this case, the control portion is preferably configured to perform control of acquiring the position of the detection object on the projection surface on the basis of detection results of the reflected light corresponding to the plurality of detection images detected by the light detection portion. According to this structure, the position of the detection object on the projection surface can be accurately grasped with the detection results of the reflected light corresponding to the plurality of detection images.

In the aforementioned structure in which the detection image is the animation image, the plurality of detection images constituting the animation image are preferably formed such that projection regions thereof on the projection surface do not overlap each other. According to this structure, the projection region of each of the detection images can be reduced in size, and hence hiding of the operation image originally projected on the projection surface behind the detection images can be suppressed even in the case where the detection image and the operation image are projected in the synthesized state. Consequently, difficulty in viewing the operation image resulting from the detection images can be suppressed even when the detection images are projected.

In this case, the control portion is preferably configured to invalidate the detection result of the reflected light from non-projection regions which are regions with which the projection regions of the plurality of detection images do not overlap. According to this structure, the position of the detection object on the projection surface can be acquired on the basis of only the light reception result of the reflected light of the projection light forming the detection images. Consequently, the position of the detection object on the projection surface can be inhibited from being erroneously acquired with light other than the projection light forming the detection images.

In the aforementioned structure in which the projection regions of the plurality of detection images do not overlap each other, the plurality of detection images constituting the animation image are preferably formed to have a prescribed separation interval smaller than the detection object between the projection regions of the plurality of detection images on the projection surface. According to this structure, the projection region of each of the detection images can be further reduced in size, and hence the hiding of the operation image behind the detection images can be minimized while the detection accuracy is maintained. Consequently, difficulty in viewing the operation image resulting from the detection images can be further suppressed when the detection images are projected.

In the aforementioned projector according to the aspect, the control portion is preferably configured to control the projection portion to project a detection image on the projection surface on the basis of that the pushed position of the display portion detected by the push detection portion has reached a prescribed pushed position before reaching an end in the pushed direction. According to this structure, the detection image starts to be projected earlier as compared with the case where the detection image is projected when the pushed position reaches the end in the pushed direction, and hence the detection image can be reliably projected during a period in which the detection object pushes the projection surface. Consequently, the position of the detection object can be reliably grasped.

In this case, the detection image preferably includes a plurality of detection images, and the control portion is preferably configured to control the projection portion to sequentially project the plurality of detection images on the projection surface according to the pushed position of the display portion detected by the push detection portion. According to this structure, the detection images can be more reliably projected during the period in which the detection object pushes the projection surface even when the plurality of detection images are projected, and hence the position of the detection object can be more reliably grasped.

In the aforementioned structure in which the plurality of detection images are sequentially projected according to the pushed position, the control portion is preferably configured to control the projection portion to sequentially project the plurality of detection images in an order reverse to an order in which the plurality of detection images are sequentially projected during the push into the display portion when the push into the display portion is released. According to this structure, the detection images can be emphasized to be the moving image (input effect) for notification of the push operation, and hence the user can be further inhibited from feeling unnatural by the detection images for position detection.

In the aforementioned structure in which the projection portion projects the detection image on the projection surface, the projector is preferably configured to acquire the position of the detection object on the projection surface on the basis of the timing of emitting the projection light forming the detection image and the timing at which the light detection portion detects the reflected light. According to this structure, the position of the detection object on the projection surface can be reliably acquired on the basis of the reflected light of the projection light forming the detection image.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a diagram showing the overall structure of a projector according to a first embodiment of the present invention;

FIG. 2 is a block diagram showing the structure of a projection portion of the projector according to the first embodiment of the present invention;

FIG. 3 is a diagram showing the structure of a light detection portion of the projector according to the first embodiment of the present invention;

FIG. 4 is a diagram showing the structure of a push detection portion of the projector according to the first embodiment of the present invention;

FIG. 5 is a block diagram showing the structure of an input detection portion of the projector according to the first embodiment of the present invention;

FIG. 6 is a diagram for illustrating the pushed state of a display portion of the projector according to the first embodiment of the present invention;

FIG. 7 is a diagram for illustrating the relationship between changes of the pushed state and image changes in the projector according to the first embodiment of the present invention;

FIG. 8 is a diagram for illustrating changes of a detection image in the projector according to the first embodiment of the present invention;

FIG. 9 is a diagram showing the overall structure of a projector according to a second embodiment of the present invention;

FIG. 10 is a diagram for illustrating the pushed state of a display portion of the projector according to the second embodiment of the present invention;

FIG. 11 is a diagram for illustrating the relationship between changes of the pushed state and image changes in the projector according to the second embodiment of the present invention;

FIG. 12 is a diagram for illustrating changes of a detection image in the projector according to the second embodiment of the present invention;

FIG. 13 is a diagram for illustrating projection regions of a plurality of detection images in the projector according to the second embodiment of the present invention;

FIG. 14 is a diagram for illustrating a method for detecting a detection object in the projector according to the second embodiment of the present invention; and

FIG. 15 is a diagram for illustrating the relationship between changes of a pushed state and image changes in a projector according to a third embodiment of the present invention.

### DESCRIPTION OF THE PREFERRED EMBODIMENTS

Embodiments of the present invention are hereinafter described with reference to the drawings.

### First Embodiment

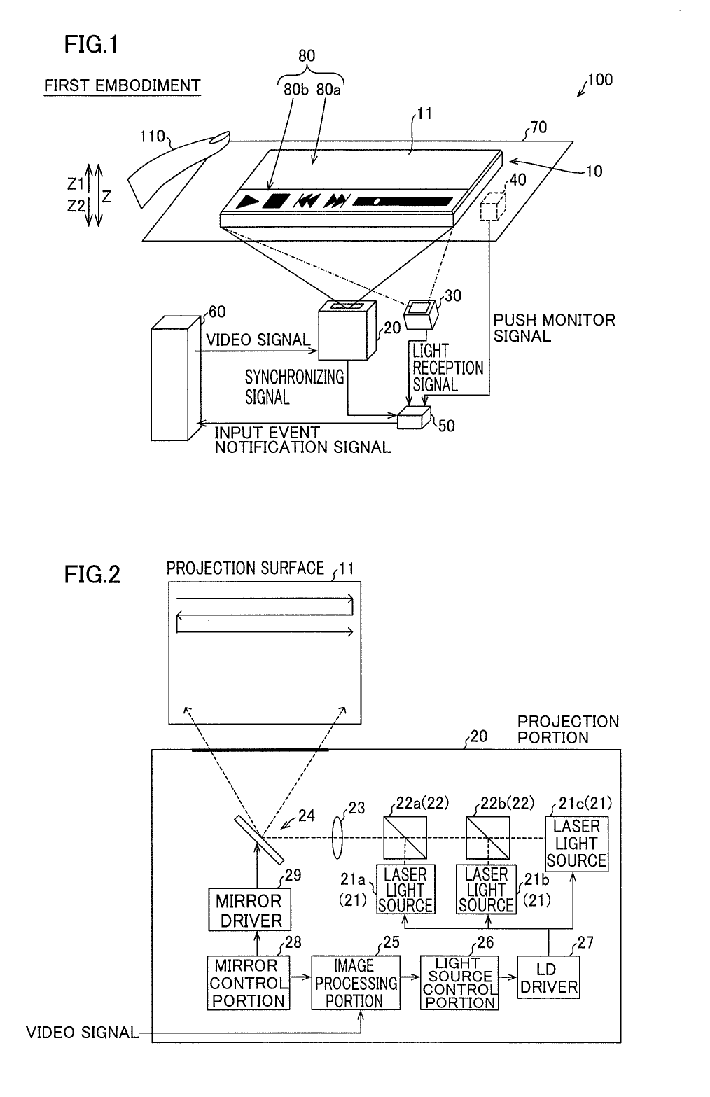

The structure of a projector 100 according to a first embodiment of the present invention is now described with reference to FIGS. 1 to 8.

The projector 100 according to the first embodiment of the present invention includes a display portion 10 having a projection surface 11 configured to display an image, capable of being pushed along arrow Z2, a projection portion 20 projecting an image on the projection surface 11, a light detection portion 30 detecting reflected light of projection light projected on the projection surface 11 and reflected by a detection object 110, a push detection portion 40 configured to detect the pushed state of the display portion 10, an input detection portion 50 receiving a detection signal (light reception signal) from the light detection portion 30 and a detection signal (push monitor signal) from the push detection portion 40, and a control portion 60 configured to control each component of the projector 100, as shown in FIG. 1. The projector 100 is arranged such that the display portion 10 is exposed outward and includes a housing 70 forming the outer shape of the projector 100.

The projector 100 is configured such that the projection portion 20 projects an image from the rear side (a side along arrow Z2) of the projection surface 11 of the display portion 10. In other words, this projector 100 performs projection onto the display portion 10 in a rear projection manner.

According to the first embodiment, the projector 100 is configured such that the projection portion 20 projects a detection image 90 described later on the projection surface 11 on the basis of detection of push into the display portion 10 by the push detection portion 40. Furthermore, the projector 100 is configured to acquire the position of the detection object 110 on the projection surface 11 on the basis of the detection result of reflected light of projection light forming the detection image 90 detected by the light detection portion 30. An operation of acquiring the position of the detection object 110 on the projection surface 11 with this detection image 90 is described later.

The display portion 10 is substantially rectangularly formed in a plan view. The display portion 10 is configured such that the upper surface (a surface along arrow Z1) thereof becomes the projection surface 11 on which the projection portion 20 projects an image. Furthermore, the display portion 10 is urged upward (along arrow Z1), and the display portion 10 can be moved downward (along arrow Z2) by a push operation performed by a user's finger or the like, for example. On the projection surface 11 of the display portion 10, an operation image 80 is displayed. FIG. 1 shows an example in which the operation image 80 of a media player screen containing a moving image display region 80a on which an unshown moving image is displayed and an image display region 80b on which images of play, stop, fast forward, rewind, a seek bar, etc. for operating this moving image are displayed is projected on the projection surface 11.

The projection portion 20 includes three (blue (B), green (G), and red (R)) laser light sources 21 (21a, 21b, and 21c), two beam splitters 22 (22a and 22b), a lens 23, a laser light scanning portion 24, an image processing portion 25, a light source control portion 26, an LD (laser diode) driver 27, a mirror control portion 28, and a mirror driver 29, as shown in FIG. 2. The projection portion 20 is configured such that the laser light scanning portion 24 scans laser light on the projection surface 11 on the basis of a video signal input into the image processing portion 25. Thus, the operation image 80 and the detection image 90 described later are projected on the projection surface 11.

The laser light source 21a is configured to emit blue laser light to the laser light scanning portion 24 through the beam splitter 22a and the lens 23. The laser light sources 21b and 21c are configured to emit green laser light and red laser light, respectively, to the laser light scanning portion 24 through the beam splitters 22b and 22a and the lens 23.

The laser light scanning portion 24 is constituted by a MEMS (Micro Electro Mechanical System) mirror. The laser light scanning portion 24 is configured to scan laser light by reflecting the laser light emitted from the laser light sources 21 by the MEMS mirror.

The image processing portion 25 is configured to control image projection on the basis of the externally input video signal. Specifically, the image processing portion 25 is configured to control driving of the laser light scanning portion 24 through the mirror control portion 28 and control laser light emission from the laser light sources 21a to 21c through the light source control portion 26 on the basis of the externally input video signal.

The light source control portion 26 is configured to control laser light emission from the laser light sources 21a to 21c by controlling the LD driver 27 on the basis of the control performed by the image processing portion 25. Specifically, the light source control portion 26 is configured to control each of the laser light sources 21a to 21c to emit laser light of a color corresponding to each pixel of a projection image in line with the scanning timing of the laser light scanning portion 24.

The mirror control portion 28 is configured to control driving of the laser light scanning portion 24 by controlling the mirror driver 29 on the basis of the control performed by the image processing portion 25.

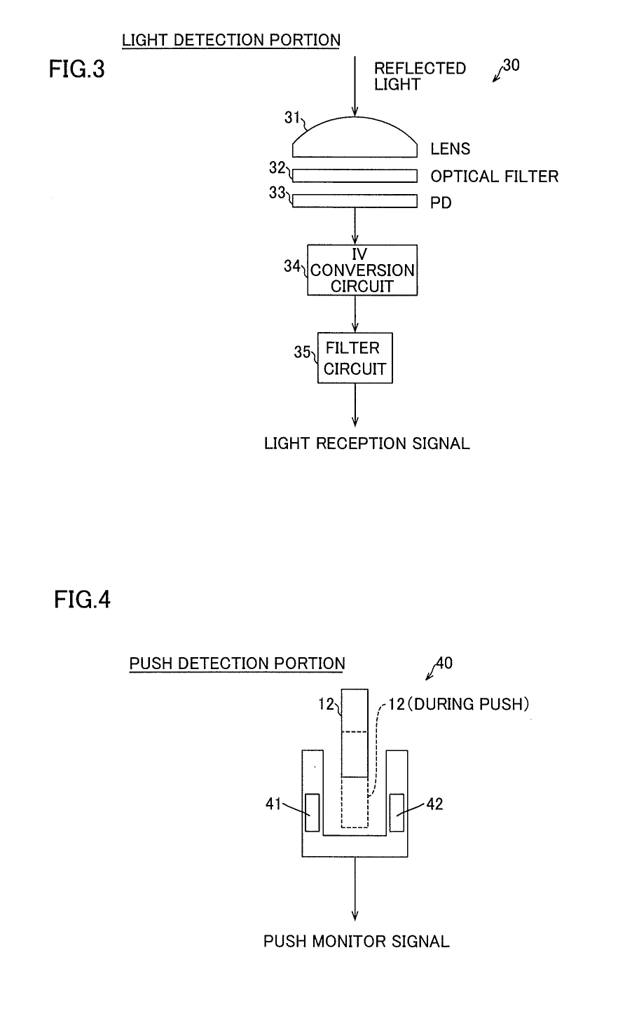

The light detection portion 30 includes a lens 31, an optical filter 32, a PD (photodiode) 33, an IV conversion circuit 34, and a filter circuit 35, as shown in FIG. 3. The light detection portion 30 is configured to output the light reception signal to the input detection portion 50 (see FIG. 1) when the reflected light reflected by the detection object 110 is received.

The lens 31 is configured to condense the reflected light reflected by the detection object 110 and guide the condensed light to the optical filter 32.

The optical filter 32 is constituted by an unshown wavelength filter and a polarizing filter. The optical filter 32 is configured to suppress passage of light of wavelengths other than light of a wavelength forming the detection image 90 by the wavelength filter and suppress passage of light reflected by the projection surface 11 by the polarizing filter.

The reflected light reflected by the detection object 110 and passing through the lens 31 and the optical filter 32 is applied to the PD 33, whereby the PD 33 generates current according to the amount of light emission.

The IV conversion circuit 34 is configured to convert the current generated by the PD 33 into voltage and output the voltage to the filter circuit 35.

The filter circuit 35 is configured to attenuate the frequency components of unnecessary light incident from a fluorescent lamp or the like.

The push detection portion 40 includes a light-emitting portion 41 emitting light and a light-receiving portion 42 receiving light from the light-emitting portion 41, as shown in FIG. 4. FIG. 4 shows a shielding portion 12 which is a part of the display portion 10 (see FIG. 1). The push detection portion 40 is configured such that the shielding portion 12 moves vertically in correspondence to movement of the display portion 10 in the vertical direction (direction Z) to shield light emitted from the light-emitting portion 41 to the light-receiving portion 41. Thus, the push detection portion 40 is configured to detect the pushed state of the display portion 10 and output the push monitor signal according to the pushed state to the input detection portion (see FIG. 1). Any push detection mechanism may be employed in the push detection portion 40 so far as the same can detect the push, and any publicly known push detection mechanism can be employed.

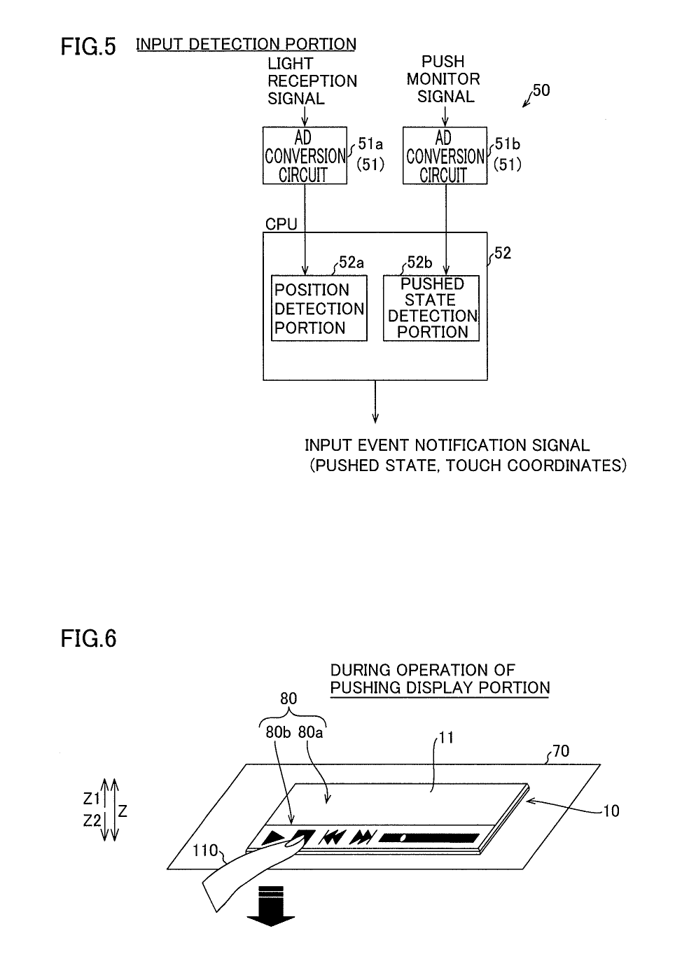

The input detection portion 50 includes two AD conversion circuits 51 (51a and 51b) and a CPU 52, as shown in FIG. 5. The CPU 52 has a position detection portion 52a and a pushed state detection portion 52b.

The two AD conversion circuits 51a and 51b are configured such that the light reception signal and the push monitor signal are input thereinto, respectively. The two AD conversion circuits 51a and 51b are configured to convert the light reception signal and the push monitor signal which are analog signals into digital signals, respectively and output the digital signals to the CPU 52.

The position detection portion 52a is configured to calculate the position of the detection object 110 (see FIG. 1) on the projection surface 11 (see FIG. 1) on the basis of the light reception signal. Specifically, the position detection portion 52a is configured to calculate the position of the detection object 110 on the projection surface 11 by referring to light scanning information defined by a function or an LUT (Look-up Table) on the basis of a difference between the reference timing (timing of emitting projection light) contained in a synchronizing signal input from the projection portion 20 (see FIG. 1) and the timing at which the light detection portion 30 (see FIG. 1) detects the reflected light reflected by the detection object 110.

The pushed state detection portion 52b is configured to acquire the pushed state of the display portion 10 (see FIG. 1) on the basis of the push monitor signal. The CPU 52 is configured to output information about the position of the detection object 110 on the projection surface 11 and information about the pushed state of the display portion 10 as an input event notification signal to the control portion 60.

The control portion 60 is configured to output a video signal to the projection portion 20, as shown in FIG. 1. Specifically, the control portion 60 is configured to output a video signal containing the operation image 80 to the projection portion 20 at the normal time when no operation is performed on the display portion 10. The control portion 60 is configured to output a video signal containing the detection image 90 described later to the projection portion 20 when the push detection portion 40 detects the push into the display portion 10. The control portion 60 is configured to output the video signal containing the operation image 80 to the projection portion 20 when completing the output of the video signal containing the detection image 90 to the projection portion 20. Furthermore, the control portion 60 is configured to output a video signal containing an image obtained by changing the operation image 80 according to the position of the detection object 110 on the projection surface 11 to the projection portion 20 when the position of the detection object 110 on the projection surface 11 is acquired from the input detection portion 50. Specifically, the control portion 60 is configured to output the video signal containing the image obtained by changing the operation image 80 according to processing corresponding to each image (icon) to the projection portion 20 when the acquired position of the detection object 110 on the projection surface 11 coincides with any one of the positions of the images (see FIG. 1) of play, stop, fast forward, rewind, a seek bar, etc. for operating the moving image. For example, the control portion 60 is configured to output a video signal indicating stop of the moving image displayed on the moving image display region 80a when the acquired position of the detection object 110 on the projection surface 11 coincides with the position of an image (icon) of a stop button and output a video signal indicating fast forward when the acquired position of the detection object 110 on the projection surface 11 coincides with the position of an image (icon) of a fast forward button. When the position of another image (icon) is acquired, the control portion 60 outputs a corresponding video signal similarly.

The detection image 90 and an operation of detecting the position of the detection object 110 with the detection image 90 in the projector 100 are now described with reference to FIGS. 1 and 6 to 8. Here, an example in which a user inputs an operation of pushing the stop button of the operation image 80 projected on the projection surface 11 is described.

First, the display portion 10 is pushed by the detection object (user's finger) 110 at a prescribed image display position of the operation image 80 displayed on the projection surface 11 of the display portion 10, as shown in FIG. 6. In other words, an image (icon) corresponding to the stop button for the moving image is pushed by the detection object 110 in FIG. 6.

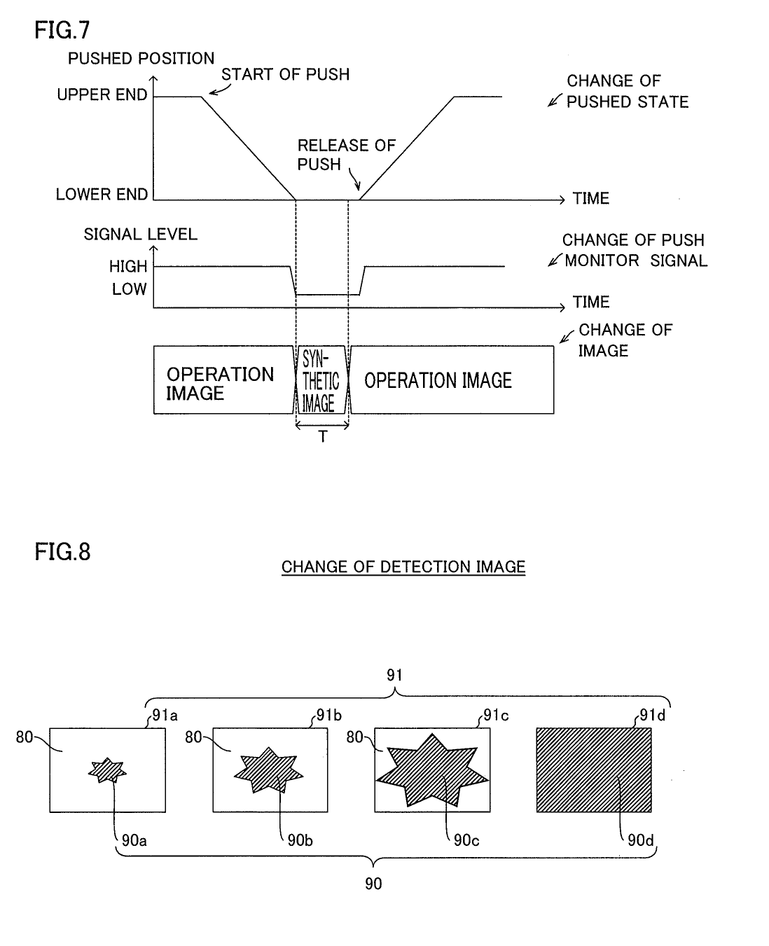

According to the first embodiment, the push detection portion 40 (see FIG. 1) outputs a low signal of the push monitor signal to the input detection portion 50 (see FIG. 1) when the pushed position of the display portion 10 (see FIG. 6) reaches an end (lower end) in a pushed direction (along arrow Z2), as shown in FIG. 7. The push detection portion 40 outputs a high signal of the push monitor signal to the input detection portion 50 when the pushed position of the display portion 10 does not reach the lower end.

When the low signal is input into the input detection portion 50, it is determined that the display portion 10 is in a pushed state, and an input event notification signal for notification of the pushed state is output to the control portion 60 (see FIG. 1).

According to the first embodiment, the control portion 60 into which the input event notification signal has been input outputs the video signal containing the detection image (shown by hatching) to the projection portion 20, as shown in FIG. 8. Then, the projection portion 20 projects the detection image 90 on the projection surface 11 on the basis of this video signal. FIG. 8 shows an image projected on the projection surface 11 of the substantially rectangular display portion 10 and changes of the image. The projected detection image 90 is formed by light of a prescribed (single) wavelength. Specifically, the detection image 90 is formed by light of a red wavelength suitable for detection of the position of the user's finger or the like.

The detection image 90 contains four detection images 90a, 90b, 90c, and 90d. The detection image 90 is an animation image (animation) formed by sequentially projecting the four detection images 90a, 90b, 90c, and 90d. Specifically, the detection image 90 is an animation image formed by gradually enlarging the first detection image 90a having a prescribed shape, passing through the enlarged intermediate detection images 90b and 90c, and projecting the last detection image 90d on an entire region of the projection surface 11.

The detection image 90 is projected on the projection surface 11 by the projection portion 20 in a state where the same is synthesized with the operation image 80. Specifically, a synthetic image 91 obtained by synthesizing (superimposingly displaying) the detection image 90 and the operation image 80 is projected on the projection surface 11 when the detection image 90 is projected on the projection surface 11. More specifically, when the detection images 90a, 90b, 90c, and 90d are projected, synthetic images 91a, 91b, 91c, and 91d obtained by synthesizing the detection images 90a, 90b, 90c, and 90d and the operation image 80, respectively, are sequentially projected on the projection surface 11 during a prescribed time period T. In FIG. 8, no picture is illustrated on the operation image 80 for the convenience of illustration.

At this time, the light detection portion 30 detects reflected light of projection light forming the four detection images 90a, 90b, 90c, and 90d sequentially projected. Then, the light detection portion 30 outputs the light reception signal to the input detection portion 50 on the basis of the detection result of the reflected light. The input detection portion 50 calculates the position of the detection object 110 on the projection surface 11 on the basis of the input light reception signal. Specifically, the input detection portion 50 calculates the position of the detection object 110 on the projection surface 11 on the basis of the light reception signal of the last detection image 90d. Then, the information about the position of the detection object 110 calculated by the input detection portion 50 is output to the control portion 60. The control portion 60 outputs the video signal containing the image obtained by changing the operation image 80 to the projection portion 20 on the basis of the input information about the position of the detection object 110. In the case of the operation image 80 shown in FIG. 6, it is detected that the detection object 110 has touched the position of an image corresponding to the stop of the moving image, and hence the moving image displayed on the display portion 10 is stopped.

It is conceivably preferable to project the detection image 90 during contact of the detection object 110 with the projection surface 11 in order to reliably detect the detection object 110 with the detection image 90. In other words, it is preferable to project the detection image 90 during a period from when the detection object 110 starts to push the projection surface 11 of the display portion 10 until when the detection object 110 releases the push. Therefore, according to the first embodiment, the projection portion 20 projects the detection image 90 on the projection surface 11 during the prescribed time period T from the pushed position (lower end) where the push detection portion 40 detects the push into the display portion 10 to a point prior to the release of the push by the detection object 110, as shown in FIG. 7. Thus, the detection image 90 can be reliably projected during a period in which the detection object 110 pushes the projection surface 11, and hence the position of the detection object 110 can be reliably grasped. The prescribed time period T is previously determined by an experiment or the like.

According to the first embodiment, the following effects can be obtained.

According to the first embodiment, as hereinabove described, the projector 100 is provided with the display portion 10 movable in the pushed direction so that the projection surface 11 is pushed, whereby the user can push the display portion 10 when operating the operation image 80 projected on the projection surface 11, and hence the user can obtain a sense of operation (the feel of push) unlike the case where the user only touches the projection surface 11. Furthermore, the projector 100 is provided with the control portion 60 acquiring the position of the detection object 110 on the projection surface 11 on the basis of the detection result of the reflected light detected by the light detection portion 30 when the push detection portion 40 detects the push into the display portion 10. Thus, a processing operation for acquiring the position is performed only when the push into the display portion 10 is detected, unlike the case where the control portion 60 acquires the position constantly, and hence the position of the detection object 110 on the projection surface 11 can be grasped while the processing load on the control portion 60 is reduced.

According to the first embodiment, as hereinabove described, the control portion 60 is configured to control the projection portion 20 to project the detection image 90 on the projection surface 11 on the basis of the detection of the push into the display portion 10 by the push detection portion 40 and perform control of acquiring the position of the detection object 110 on the projection surface 11 on the basis of the detection result of the reflected light of the projection light forming the detection image 90 detected by the light detection portion 30. Thus, both the detection image 90 and the operation image 80 can be projected by the projection portion 20, and hence an increase in the number of components of the projection portion 20 of the projector 100 can be suppressed, unlike the case where a projection portion for the detection image 90 is provided separately from a projection portion for the operation image 80. Furthermore, the projection light forming the detection image 90 dedicated for detection is employed for detection, whereby the position of the detection object 110 can be accurately detected, unlike the case where projection light for the operation image 80 is employed for detection. In addition, unlike the case where the detection image 90 (detection light) and the operation image 80 are simultaneously projected on a constant basis, the position can be detected simply by projecting the detection image 90 temporarily when the user operates the operation image 80 projected on the projection surface 11, and hence superimpose display of the detection image 90 and the operation image 80 can be suppressed. Thus, difficulty in viewing the operation image 80 can be suppressed.

According to the first embodiment, as hereinabove described, the control portion 60 is configured to control the projection portion 20 to project the detection image 90 on the projection surface 11 when the push detection portion 40 detects the push into the display portion 10 and control the projection portion 20 to project the operation image 80 different from the detection image 90 on the projection surface 11 when the projection portion 20 completes the projection of the detection image 90 on the projection surface 11. Thus, the detection image 90 can be properly projected on the projection surface 11 when it is necessary to detect the position of the detection object 110, and the operation image 80 can be promptly projected on the projection surface 11 after the position of the detection object 110 is detected.

According to the first embodiment, as hereinabove described, the control portion 60 is configured to control the projection portion 20 to project the detection image 90 and the operation image 80 on the projection surface 11 in the state where the detection image 90 and the operation image 80 different from the detection image 90 are synthesized. Thus, both the detection image 90 and the operation image 80 are projected on the projection surface 11 even during the projection of the detection image 90 on the projection surface 11, and hence the position of the detection object 110 can be acquired while the user is allowed to visually confirm the operation image 80.

According to the first embodiment, as hereinabove described, the control portion 60 is configured to control the projection portion 20 to project the detection image 90 on the projection surface 11 during the period from when the push detection portion 40 detects the push into the display portion 10 until when the push into the display portion 10 is released. Thus, the detection image 90 can be projected during the push of the detection object 110 into the projection surface 11 (during the contact of the detection object 110 with the projection surface 11), and hence the light forming the detection image 90 can be reliably reflected by the detection object 110. Consequently, the position of the detection object 110 can be reliably acquired on the basis of the reflected light.

According to the first embodiment, as hereinabove described, the projection light forming the detection image 90 is formed by the light of the single wavelength. Thus, the reflected light of the single wavelength reflected by the detection object 110 can be easily detected by the light detection portion 30, unlike the case where the detection image 90 is formed by light of various wavelengths.

According to the first embodiment, as hereinabove described, the projection light forming the detection image 90 is formed by the light of the red wavelength. A light receiving element such as the PD 33 whose photosensitivity is generally high in a red wavelength region is employed as a light receiving element of the light detection portion 30. Therefore, according to the aforementioned structure, the light of the red wavelength which is a wavelength for which the photosensitivity of the light receiving element (PD 33) of the light detection portion 30 is high is employed, and hence the reflected light reflected by the detection object 110 can be more easily detected by the light detection portion 30.

According to the first embodiment, as hereinabove described, the detection image 90 is the animation image formed by sequentially projecting a plurality of detection images 90a, 90b, 90c, and 90d. Thus, the detection image 90 can be displayed as a moving image (input effect) for notification of a push operation. Consequently, the detection image 90 for position detection can be projected while the user is inhibited from feeling unnatural.

According to the first embodiment, as hereinabove described, the plurality of detection images 90a, 90b, 90c, and 90d are the animation image sequentially changing by gradually enlarging the first detection image 90a of the plurality of detection images 90a, 90b, 90c, and 90d. Thus, the user can be further inhibited from feeling unnatural by the detection images 90a, 90b, 90c, and 90d for position detection.

According to the first embodiment, as hereinabove described, the control portion 60 is configured to perform control of acquiring the position of the detection object 110 on the projection surface 11 on the basis of the detection result of the reflected light of the projection light forming the last detection image 90d of the plurality of detection images 90a, 90b, 90c, and 90d constituting the animation image, detected by the light detection portion 30. Thus, the detection result of the reflected light of the projection light forming the detection image 90d projected last can be employed, and hence the position of the detection object 110 on the projection surface 11 can be acquired in a state where the position of the detection object 110 on the projection surface 11 is fixed. Consequently, the position of the detection object 110 on the projection surface 11 can be accurately acquired.

According to the first embodiment, as hereinabove described, the control portion 60 is configured to perform control of acquiring the position of the detection object 110 on the projection surface 11 on the basis of the detection result of the reflected light of the projection light forming the last detection image 90d detected by the light detection portion 30. Thus, in the structure of acquiring the position of the detection object 110 on the projection surface 11 on the basis of the detection result of the reflected light of the projection light forming the last detection image 90d detected by the light detection portion 30, the projection light forming the last detection image 90d can be reflected by the detection object 110, unlike the case where the last detection image 90d is projected only on a partial region of the projection surface 11. Consequently, the position of the detection object 110 on the projection surface 11 can be reliably and accurately acquired regardless of the position of the detection object 110.

According to the first embodiment, as hereinabove described, the control portion 60 is configured to perform control of acquiring the position of the detection object 110 on the projection surface 11 on the basis of the detection result of the reflected light of the projection light forming at least one (detection image 90d) of the plurality of detection images 90a, 90b, 90c, and 90d constituting the animation image, detected by the light detection portion 30. Thus, the position of the detection object 110 on the projection surface 11 can be reliably acquired even in the case where the detection images 90a, 90b, 90c, and 90d are the animation image.

According to the first embodiment, as hereinabove described, the input detection portion 50 is configured to acquire the position of the detection object 110 on the projection surface 11 on the basis of the timing of emitting the projection light forming the detection image 90 and the timing at which the light detection portion 30 detects the reflected light. Thus, the position of the detection object 110 on the projection surface 11 can be reliably acquired on the basis of the reflected light of the projection light forming the detection image 90.

### Second Embodiment

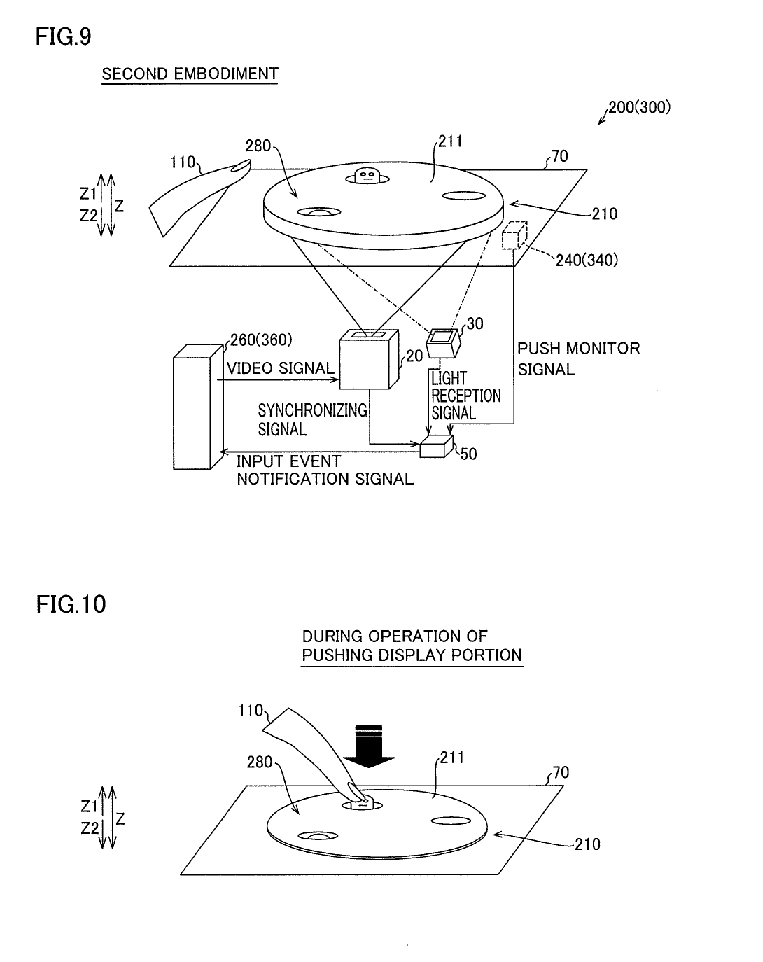

A second embodiment is now described with reference to FIGS. 9 to 14. In this second embodiment, an operation image 280 is projected as a game image on a display portion 210 of a projector 200, unlike the aforementioned first embodiment in which the operation image 80 containing the moving image and the image for operating this moving image is projected on the display portion 10 of the projector 100. Furthermore, in this second embodiment, a detection image 290 constituting a moving image (animation) different from that of the aforementioned first embodiment is employed for detection.

The projector 200 includes the display portion 210 having a projection surface 211, capable of being pushed along arrow Z2, a push detection portion 240 configured to detect the pushed state of the display portion 210, and a control portion 260 configured to control each component of the projector 200, as shown in FIG. 9. Portions similar to those in the aforementioned first embodiment shown in FIG. 1 are denoted by the same reference numerals, to omit the description.

The display portion 210 is similar in structure to the display portion 10 according to the first embodiment except for having a substantially ellipsoidal shape in a plan view.

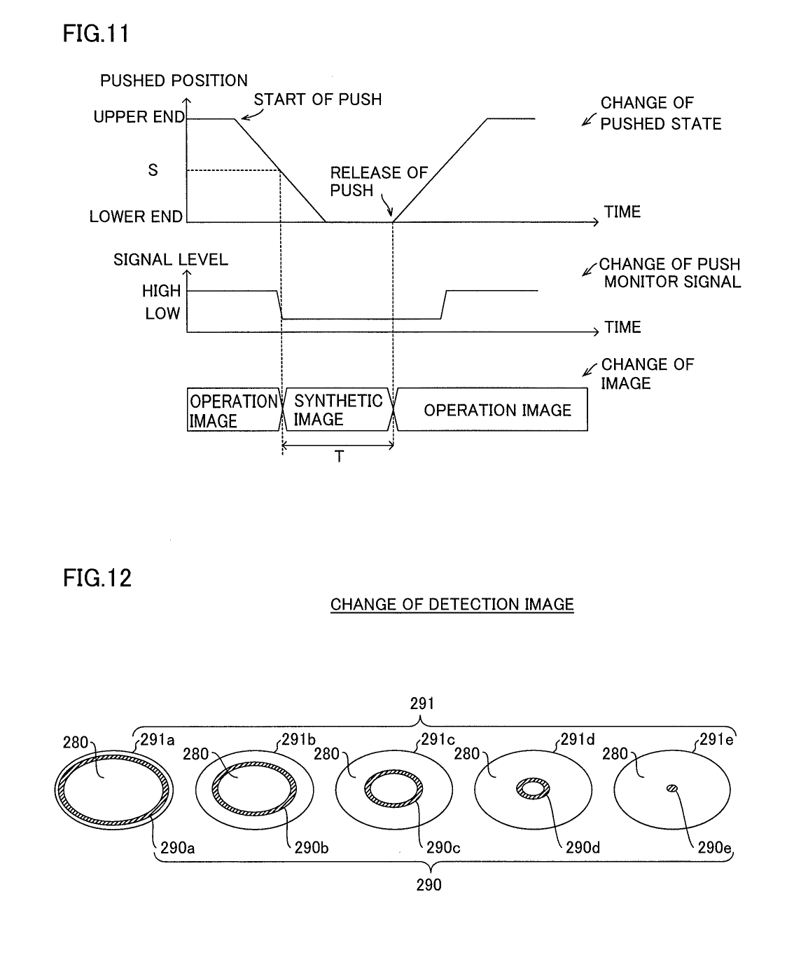

The push detection portion 240 is configured to output a low signal of a push monitor signal to an input detection portion 50 on the basis of that the pushed position of the display portion 210 has reached a prescribed pushed position (a pushed position S in FIG. 11) before reaching a lower end in a pushed direction (along arrow Z2). The prescribed pushed position may be set to any pushed position between an upper end and the lower end.

The control portion 260 is configured to control a projection portion 20 to project the operation image 280 as the game image and the detection image 290 described later on the projection surface 211 of the display portion 210. In FIG. 9, an example of projecting the operation image 280 of a whack-a-mole game as the game image on the projection surface 211 is shown.

The detection image 290 and an operation of detecting the position of a detection object 110 with the detection image 290 in the projector 200 are now described with reference to FIGS. 10 to 14.

First, the display portion 210 is pushed by the detection object 110 at a prescribed image position of the operation image 280 displayed on the projection surface 211 of the display portion 210, as shown in FIG. 10. In FIG. 10, the display portion 210 is pushed by the detection object 110 at the position of an image of a mole appearing from a hole.

According to the second embodiment, when the pushed position of the display portion 210 (see FIG. 10) reaches the prescribed pushed position S before reaching the lower end in the pushed direction (along arrow Z2), the push detection portion 240 (see FIG. 9) outputs the low signal of the push monitor signal to the input detection portion 50 (see FIG. 9), as shown in FIG. 11. Then, the input detection portion 50 outputs an input event notification signal for notification of the pushed state to the control portion 260 (see FIG. 9).

As shown in FIG. 12, the control portion 260 outputs a video signal containing the detection image 290 (shown by hatching) to the projection portion 20. Then, the projection portion 20 projects the detection image 290 on the projection surface 211 on the basis of this video signal. In FIG. 12, an image projected on the projection surface 211 of the substantially ellipsoidal display portion 210 and changes of the image are shown.

The projected detection image 290 is formed by light of a red wavelength, similarly to the first embodiment. The detection image 290 contains five detection images 290a, 290b, 290c, 290d, and 290e. The detection image 290 is an animation image (animation) formed by sequentially projecting the five detection images 290a, 290b, 290c, 290d, and 290e. Specifically, the detection image 290 is an animation image formed by gradually reducing the first detection image 290a having an ellipsoidally annular shape, passing through the reduced intermediate detection images 290b, 290c, and 290d, and projecting the last detection image 290e having an ellipsoidal shape on a substantially central region of the projection surface 211.

The detection image 290 is projected on the projection surface 211 by the projection portion 20 in a state where the detection image 290 is synthesized with the operation image 280, similarly to the first embodiment. In other words, a synthetic image 291 (291a, 291b, 291c, 291d, and 291e) containing the five detection images 290a, 290b, 290c, 290d, and 290e is sequentially projected on the projection surface 211 during a prescribed time period T. In FIG. 12, no picture is illustrated on the operation image 280 for the convenience of illustration.

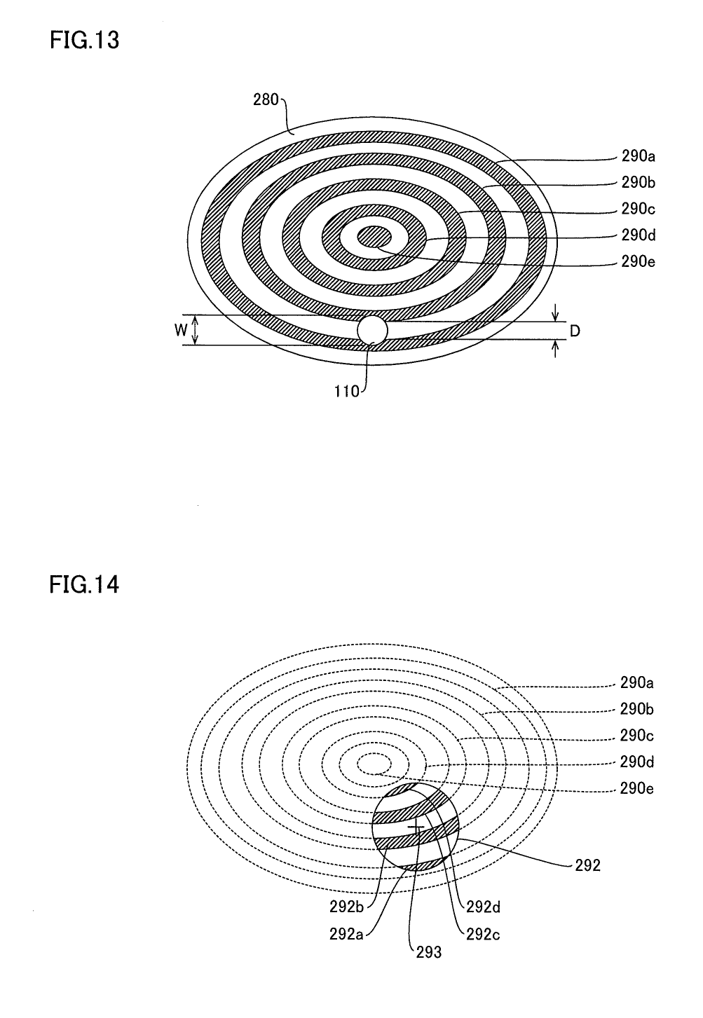

According to the second embodiment, the detection image 290 is projected such that projection regions of the five detection images 290a, 290b, 290c, 290d, and 290e do not overlap each other, as shown in FIG. 13. FIG. 13 is a diagram showing the case where the sequentially projected detection images 290a, 290b, 290c, 290d, and 290e are superimposed. The detection image 290 has a prescribed separation interval D smaller than the width W of the detection object 110 between the projection regions of the five detection images 290a, 290b, 290c, 290d, and 290e. Here, a user's finger is assumed as the detection object 110, and hence the separation interval D is set to be sufficiently small in view of the size of the width W of a portion of the user's finger contact with the projection surface 211 during push.

According to the second embodiment, the projector 200 is configured to be capable of detecting an entire region of the projection surface 211 on the basis of the detection results of the five detection images 290a, 290b, 290c, 290d, and 290e and the combinations thereof, unlike the projector 100 according to the first embodiment configured to be capable of detecting the entire region of the projection surface with the detection image 90d projected last.

Specifically, a plurality of detection areas 292a, 292b, 292c, and 292d are detected with a plurality of detection images 290a, 290b, 290c, and 290d, as shown in FIG. 14. More specifically, a light detection portion 30 detects the detection areas 292a, 292b, 292c, and 292d (shown by hatching) corresponding to the detection images 290a, 290b, 290c, and 290d with the detection images 290a, 290b, 290c, and 290d, respectively. Then, the input detection portion 50 calculates a detection area 292 containing the detection areas 292a, 292b, 292c, and 292d on the basis of a light reception signal of the light detection portion 30. Then, a detection position 293 in the detection area 292 is recognized as a detection position, and coordinate information corresponding to the detection position 293 is output to the control portion 260. Thus, the control portion 260 outputs a video signal containing an image obtained by changing the operation image 280 to the projection portion 20, and the operation image 280 is changed on the basis of the position detection result. In the case of the operation image 280 shown in FIG. 10, it is detected that the detection object 110 has touched the position of the image of the mole appearing from the hole, and hence the operation image 280 according to the game, such as an image in which the mole moves into the hole, for example, is displayed. The detection position 293 may be located at the geometric center of the detection area 292 or the center of gravity of the detection area 292, or may be determined by another method.

When the position of the detection object 110 on the projection surface is detected with a plurality of detection images 290a, 290b, 290c, 290d, and 290e projected such that the projection regions thereof do not overlap each other, detection of reflected light obtained from non-projection regions (regions between the detection images 290) which are regions with which the projection regions of the detection images 290 do not overlap may be disabled. According to this structure, the detection of the reflected light related to the operation image 280 is disabled even in the case where the operation image 280 projected on the non-projection regions is formed by light of a wavelength component similar to those of the detection images 290a, 290b, 290c, 290d, and 290e, for example, and hence the position of the detection object 110 on the projection surface 210 can be reliably detected.

The remaining structure of the projector 200 according to the second embodiment is similar to that of the projector 100 according to the aforementioned first embodiment.

According to the second embodiment, the following effects can be obtained.

According to the second embodiment, as hereinabove described, the control portion 260 is configured to perform control of acquiring the position of the detection object 110 on the projection surface 211 on the basis of the detection results of the reflected light corresponding to the plurality of detection images 290a, 290b, 290c, 290d, and 290e detected by the light detection portion 30. Thus, the position of the detection object 110 on the projection surface 211 can be accurately grasped with the detection results of the reflected light corresponding to the plurality of detection images 290a, 290b, 290c, 290d, and 290e.

According to the second embodiment, as hereinabove described, the plurality of detection images 290a, 290b, 290c, 290d, and 290e constituting the animation image are formed such that the projection regions thereof on the projection surface 211 do not overlap each other. Thus, the projection region of each of the detection images 290a, 290b, 290c, 290d, and 290e can be reduced in size, and hence hiding of the operation image 280 originally projected on the projection surface 211 behind the detection images 290a, 290b, 290c, 290d, and 290e can be suppressed. Consequently, difficulty in viewing the operation image 280 resulting from the detection images 290a, 290b, 910c, 290d, and 290e can be suppressed even when the detection images 290a, 290b, 290c, 290d, and 290e are projected.

According to the second embodiment, as hereinabove described, the plurality of detection images 290a, 290b, 290c, 290d, and 290e constituting the animation image have the prescribed separation interval smaller than the detection object 110 between the projection regions of the detection images on the projection surface 211. Thus, the projection region of each of the detection images 290a, 290b, 290c, 290d, and 290e can be further reduced in size, and hence the hiding of the operation image 280 behind the detection images 290a, 290b, 290c, 290d, and 290e can be minimized while the detection accuracy is maintained. Consequently, difficulty in viewing the operation image 280 resulting from the detection images 290a, 290b, 290c, 290d, and 290e can be further suppressed when the detection images 290a, 290b, 290c, 290d, and 290e are projected.

According to the second embodiment, as hereinabove described, the control portion 260 is configured to invalidate the detection result of the reflected light from the non-projection regions which are the regions with which the projection regions of the plurality of detection images 290a, 290b, 290c, 290d, and 290e do not overlap. Thus, the position of the detection object 110 on the projection surface can be acquired on the basis of only the light reception result of the reflected light of the projection light forming the detection images 290a, 290b, 290c, 290d, and 290e. Consequently, the position of the detection object 110 on the projection surface 211 can be inhibited from being erroneously acquired with light other than the projection light forming the detection images 290a, 290b, 290c, 290d, and 290e.

According to the second embodiment, as hereinabove described, the plurality of detection images 290a, 290b, 290c, 290d, and 290e are the animation image sequentially changing by gradually reducing the first detection image 290a of the plurality of detection images 290a, 290b, 290c, 290d, and 290e. Thus, also according to this second embodiment, a user can be further inhibited from feeling unnatural by the detection images 290a, 290b, 290c, 290d, and 290e for position detection.

According to the second embodiment, as hereinabove described, the control portion 260 is configured to control the projection portion 20 to project the detection image 290 on the projection surface 211 on the basis of that the pushed position of the display portion 210 detected by the push detection portion 40 has reached the prescribed pushed position before reaching the end in the pushed direction. Thus, the detection image 290 starts to be projected earlier as compared with the case where the detection image 290 is projected when the pushed position reaches the end in the pushed direction, and hence the detection image 290 can be reliably projected during a period in which the detection object 110 pushes the projection surface 211. Consequently, the position of the detection object 110 can be reliably grasped.

The remaining effects of the second embodiment are similar to those of the aforementioned first embodiment.

### Third Embodiment

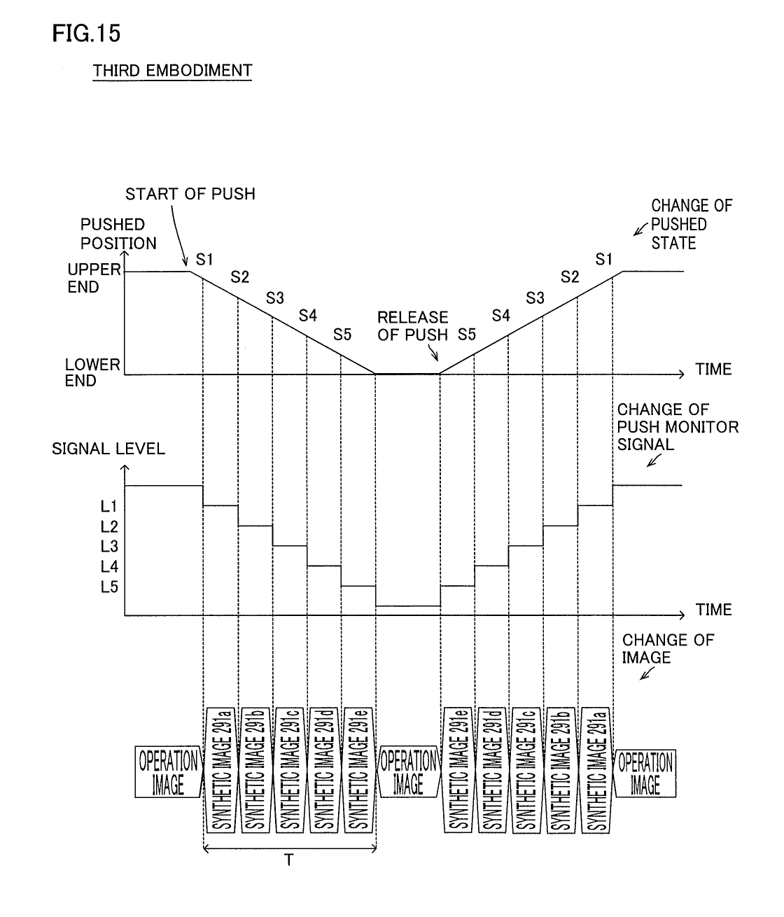

A third embodiment is now described with reference to FIGS. 9 and 15. In this third embodiment, a detection image 290 is projected on a projection surface 211 according to the pushed position of a display portion 210 in a projector 300, unlike the first and second embodiments.

The projector 300 includes a push detection portion 340 and a control portion 360, as shown in FIG. 9. The remaining portions are similar to those in the aforementioned second embodiment shown in FIG. 9, and hence the portions are denoted by the same reference numerals, to omit the description.

The push detection portion 340 is configured to output a push monitor signal to an input detection portion 50 according to the pushed position of the display portion 210. Specifically, the push detection portion 340 is configured to detect five pushed positions S1, S2, S3, S4, and S5 according to the pushed position of the display portion 210 and output push monitor signals based on signal levels L1, L2, L3, L4, and L5 corresponding to the respective pushed positions to the input detection portion 50, as shown in FIG. 15. In the push detection portion 340, any push detection mechanism may be employed so far as the same can detect push according to the pushed position of the display portion 210. For example, a plurality of light reception portions 42 of the push detection portion 40 shown in FIG. 4 may be provided to detect the pushed states of the display portion 210 corresponding to the pushed positions.

The control portion 360 (see FIG. 9) is configured to control a projection portion 20 to sequentially project five synthetic images 291a, 291b, 291c, 291d, and 291e containing five detection images 290a, 290b, 290c, 290d, and 290e, respectively, according to the five pushed positions of the display portion 210 detected by the push detection portion 340. Furthermore, the control portion 360 is configured to control the projection portion 20 to project an operation image 280 on the projection surface 211 when the push detection portion 340 detects that the pushed position of the display portion 210 reaches a lower end. In addition, the control portion 360 is configured to control the projection portion 20 to sequentially project the five synthetic images 291a, 291b, 291c, 291d, and 291e in an order reverse to that during push when the push into the display portion 210 is released and the pushed position returns from the lower end to an upper end.

The remaining structure of the projector 300 according to the third embodiment is similar to that of the projector 100 according to the aforementioned first embodiment.

According to the third embodiment, the following effects can be obtained.

According to the third embodiment, as hereinabove described, the detection image 290 contains a plurality of detection images 290a, 290b, 290c, 290d, and 290e, and the control portion 360 is configured to control the projection portion 20 to sequentially project the plurality of detection images 290a, 290b, 290c, 290d, and 290e on the projection surface 211 according to the pushed position of the display portion detected by the push detection portion 340. According to this structure, the detection images 290a, 290b, 290c, 290d, and 290e can be more reliably projected during a period in which a detection object 110 pushes the projection surface 211 even when the plurality of detection images 290a, 290b, 290c, 290d, and 290e are projected, and hence the position of the detection object 110 can be more reliably grasped.

According to the third embodiment, as hereinabove described, the control portion 360 is configured to control the projection portion 20 to sequentially project the plurality of detection images 290a, 290b, 290c, 290d, and 290e in the order reverse to the order in which the detection images are sequentially projected during the push into the display portion 210 when the push into the display portion 210 is released. Thus, the detection images 290a, 290b, 290c, 290d, and 290e can be emphasized to be a moving image (input effect) for notification of a push operation, and hence a user can be further inhibited from feeling unnatural by the detection images 290a, 290b, 290c, 290d, and 290e for position detection.

The remaining effects of the third embodiment are similar to those of the aforementioned first embodiment.

The embodiments disclosed this time must be considered as illustrative in all points and not restrictive. The range of the present invention is shown not by the above description of the embodiments but by the scope of claims for patent, and all modifications within the meaning and range equivalent to the scope of claims for patent are further included.

For example, while the plurality of detection images 90a, 90b, 90c, and 90d (290a, 290b, 290c, 290d, and 290e) constitute the animation image in each of the aforementioned first to third embodiments, the present invention is not restricted to this. According to the present invention, the position of the detection object 110 may alternatively be detected with one detection image so far as the position of the detection object 110 can be detected. For example, only the detection image 90d according to the first embodiment may be projected as the detection image. Furthermore, the five detection images 290a, 290b, 290c, 290d, and 290e according to each of the second and third embodiments may be projected simultaneously as one detection image.

While the four (five) detection images 90a, 90b, 90c, and 90d (290a, 290b, 290c, 290d, and 290e) constitute the animation image in each of the aforementioned first to third embodiments, the present invention is not restricted to this. According to the present invention, a plurality other than four or five of detection images may alternatively constitute the animation image.

While the detection image 90 (290) is formed by the light of the red wavelength in each of the aforementioned first to third embodiments, the present invention is not restricted to this. According to the present invention, the detection image may alternatively be formed by light of a wavelength other than the red wavelength. For example, the detection image may be formed by light of a green or blue wavelength.

While the detection image 90 (290) is formed by the light of the single wavelength in each of the aforementioned first to third embodiments, the present invention is not restricted to this. According to the present invention, the detection image may not be formed by the light of the single wavelength. In this case, the detection image is preferably formed by light of a large number of prescribed wavelengths for detection in order to maintain the detection sensitivity. Furthermore, in this case, the operation image 80 (280) may be contained in the detection image by mixing the light of the prescribed wavelengths with the operation image 80 (280) when the detection image is projected. Even according to this structure, difficulty in viewing the operation image resulting from the detection image can be suppressed when the detection image is projected.

While the input detection portion 50 calculates the position of the detection object 110 on the projection surface 11 on the basis of the light reception signal of the last detection image 90d in the aforementioned first embodiment, the present invention is not restricted to this. According to the present invention, the input detection portion 50 may alternatively calculate the position of the detection object 110 on the projection surface 11 on the basis of not only the light reception signal of the last detection image 90d but also light reception signals of the first detection image 90a and the intermediate detection images 90b and 90c.

While the detection image 290 has the prescribed separation interval D smaller than the width W of the detection object 110 between the projection regions of the five detection images 290a, 290b, 290c, 290d, and 290e in the aforementioned second embodiment, the present invention is not restricted to this. According to the present invention, the detection image 290 containing the five detection images 290a, 290b, 290c, 290d, and 290e may not have the prescribed separation interval. For example, the detection image 290 may be projected such that there is no clearance between the projection regions of the five detection images 290a, 290b, 290c, 290d, and 290e.

While the entire region of the projection surface 211 can be detected on the basis of the detection images 290a, 290b, 290c, 290d, and 290e having the ellipsoidally annular shapes and the ellipsoidal shape concentrically expanding in the aforementioned second embodiment, the present invention is not restricted to this. According to the present invention, detection images each having another shape may alternatively be employed so far as the entire region of the projection surface can be detected. For example, rectangular (bar-shaped) detection images (animation image) sliding from one end of the projection surface to the other may be employed.

While the detection image 90d projected last is projected on the entire region of the projection surface 11 in the aforementioned first embodiment, the present invention is not restricted to this. According to the present invention, the detection image may not be projected on the entire region of the projection surface 11 when an operating range is previously known. For example, the detection image may alternatively be projected only on the image display region 80b when a region where the image display region 80b for operating the moving image is displayed is known as in the first embodiment.

While the projection portion 20 projects the detection image 90 (290) on the projection surface 11 (211) on the basis of the detection of the push into the display portion (210) by the push detection portion 40 (240, 340), and the control portion 60 (260, 360) acquires the position of the detection object 110 on the projection surface 11 (211) on the basis of the detection result of the reflected light of the projection light forming the detection image 90 (290) in each of the aforementioned first to third embodiments, the present invention is not restricted to this. According to the present invention, the control portion may alternatively acquire the position of the detection object 110 on the projection surface on the basis of a detection result of reflected light of projection light forming the operation image without projecting the detection image on the projection surface on the basis of the detection of the push into the display portion by the push detection portion.

While the input detection portion 50 acquires (calculates) the position of the detection object 110 on the projection surface 11 on the basis of the timing of emitting the projection light forming the detection image 90 (290) and the timing at which the light detection portion 30 detects the reflected light in each of the aforementioned first to third embodiments, the present invention is not restricted to this. According to the present invention, the control portion may alternatively acquire (calculate) the position of the detection object on the projection surface on the basis of the timing of emitting the projection light forming the detection image and the timing at which the light detection portion detects the reflected light without providing the input detection portion.

What is claimed is:

1. A projector comprising:
a projection portion projecting an image;
a display portion having a projection surface configured to display the image projected by the projection portion, movable in a pushed direction so that the projection surface is pushed;
a push detection portion configured to detect movement of the display portion caused by push;
a light detection portion detecting reflected light of projection light projected on the projection surface by the projection portion and reflected by a detection object; and
a control portion acquiring a position of the detection object on the projection surface on the basis of a detection result of the reflected light detected by the light detection portion when the push detection portion detects the push into the display portion.

2. The projector according to claim 1, wherein
the control portion is configured to control the projection portion to project a detection image on the projection surface on the basis of detection of the push into the display portion by the push detection portion and perform control of acquiring the position of the detection object on the projection surface on the basis of the detection result of the reflected light of the projection light forming the detection image, detected by the light detection portion.

3. The projector according to claim 1, wherein
the control portion is configured to control the projection portion to project a detection image on the projection surface when the push detection portion detects the push into the display portion and control the projection portion to project an operation image different from the detection image on the projection surface when the projection portion completes projection of the detection image on the projection surface.

4. The projector according to claim 2, wherein
the control portion is configured to control the projection portion to project the detection image and an operation image on the projection surface in a state where the detection image and the operation image different from the detection image are synthesized.

5. The projector according to claim 2, wherein
the control portion is configured to control the projection portion to project the detection image on the projection surface during a period from when the push detection portion detects the push into the display portion until when the push into the display portion is released.

6. The projector according to claim 2, wherein
the projection light forming the detection image is formed by light of a single wavelength.

7. The projector according to claim 6, wherein
the projection light forming the detection image is formed by light of a red wavelength.

8. The projector according to claim 2, wherein
the detection image is an animation image formed by sequentially projecting a plurality of detection images.

9. The projector according to claim 8, wherein
the plurality of detection images are the animation image sequentially changing by gradually enlarging or reducing a first detection image of the plurality of detection images.

10. The projector according to claim 8, wherein
the control portion is configured to perform control of acquiring the position of the detection object on the projection surface on the basis of the detection result of the reflected light of the projection light forming a last detection image of the plurality of detection images constituting the animation image, detected by the light detection portion.

11. The projector according to claim 10, wherein
the last detection image is an image projected on a substantially entire region of the projection surface, and
the control portion is configured to perform control of acquiring the position of the detection object on the projection surface on the basis of the detection result of the reflected light of the projection light forming the last detection image detected by the light detection portion.

12. The projector according to claim 8, wherein
the control portion is configured to perform control of acquiring the position of the detection object on the projection surface on the basis of the detection result of the reflected light of the projection light forming at least one of the plurality of detection images constituting the animation image, detected by the light detection portion.

13. The projector according to claim 12, wherein
the control portion is configured to perform control of acquiring the position of the detection object on the projection surface on the basis of detection results of the reflected light corresponding to the plurality of detection images detected by the light detection portion.

14. The projector according to claim 8, wherein
the plurality of detection images constituting the animation image are formed such that projection regions thereof on the projection surface do not overlap each other.

15. The projector according to claim 14, wherein
the control portion is configured to invalidate the detection result of the reflected light from non-projection regions which are regions with which the projection regions of the plurality of detection images do not overlap.

16. The projector according to claim 14, wherein
the plurality of detection images constituting the animation image are formed to have a prescribed separation interval smaller than the detection object between the projection regions of the plurality of detection images on the projection surface.

17. The projector according to claim 1, wherein
the control portion is configured to control the projection portion to project a detection image on the projection surface on the basis of that a pushed position of the display portion detected by the push detection portion has reached a prescribed pushed position before reaching an end in the pushed direction.

18. The projector according to claim 17, wherein
the detection image comprises a plurality of detection images, and
the control portion is configured to control the projection portion to sequentially project the plurality of detection images on the projection surface according to the pushed position of the display portion detected by the push detection portion.

19. The projector according to claim 18, wherein
the control portion is configured to control the projection portion to sequentially project the plurality of detection images in an order reverse to an order in which the plurality of detection images are sequentially projected during the push into the display portion when the push into the display portion is released.

20. The projector according to claim 2, configured to acquire the position of the detection object on the projection surface on the basis of timing of emitting the projection light forming the detection image and timing at which the light detection portion detects the reflected light.
